(19) United States
(12) Patent Application Publication
(10) Pub. No.: US 2016/0224671 A1
(43) Pub. Date: Aug. 4, 2016

(54) CONTENT MANAGEMENT ACROSS MULTIPLE MEDIUMS

(71) Applicant: EMPIRE TECHNOLOGY DEVELOPMENT LLC, Wilmington, DE (US)

(72) Inventor: Yang-Won Jung, Seoul (KR)

(21) Appl. No.: 14/377,607

(22) PCT Filed: Aug. 13, 2013
(86) PCT No.: PCT/US13/54685

§ 371 Date: Aug. 8, 2014

(51) Int. Cl. G06F 17/30; H04L 29/08

(52) U.S. Cl. CPC G06F 17/30867; H04L 67/06; G06F 17/3012; G06F 17/30091; G06F 17/3053

(57) ABSTRACT

Technologies are generally described for content management. In some examples, a method may include uploading, by an electronic device, to a server of at least one social networking service (SNS), a media file stored in the electronic device; receiving, by the server, one or more user reactions to the media file; transmitting, by the server, to the electronic device, the one or more user reactions; storing, by the electronic device, the one or more user reactions in connection with the media file; and showing, by the electronic device, the one or more user reactions in connection with the media file when a user of the electronic device browses the media file.

### BACKGROUND

Social network services (SNSs) such as, for example, Facebook®, Twitter®, etc., are widely used worldwide. A user can take a photo, capture a video, and/or capture audio using a camera and/or a microphone equipped with his/her phone or tablet computer, and share the resulting media file on a variety of SNSs.

### SUMMARY

In an example, a method may include uploading, by an electronic device to a server of at least one social networking service (SNS), a media file stored in the electronic device; receiving, by the server, one or more user reactions to the media file; transmitting, by the server to the electronic device, the one or more user reactions; storing, by the electronic device, the one or more user reactions in connection with the media file; and showing, by the electronic device, the one or more user reactions in connection with the media file when a user of the electronic device browses the media file.

In another example, a method performed under control of a content manager, may include receiving, from a respective one of one or more servers to which a media file has been uploaded, information regarding the media file that has been added via the respective one of the one or more servers; and storing, in a storage, the received information in connection with the media file.

In yet another example, an electronic device may include a transmitter unit configured to transmit a media file to a server; a receiver unit configured to receive, from the server, information regarding the media file that has been added via the server; a content management unit configured to associate the received information with the media file; and a storage unit configured to store the media file and the information associated with the media file.

In still another example, a computer-readable storage medium may store thereon computer-executable instructions that, in response to execution, cause a processor to perform operations, including uploading a media file to a social networking service (SNS) server; receiving, from the SNS server, information regarding the media file that includes at least one of favorability ratings for the media file, information regarding authors of respective ones of the favorability ratings for the media file, comments posted to the media file, or information regarding authors of respective ones of the comments posted to the media file; and storing the received information as metadata of the media file.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an illustrative example of an environment in which an electronic device interacts with one or more social networking service (SNS) servers to implement content management across multiple mediums, arranged in accordance with at least some embodiments described herein;

FIG. 2 shows a schematic block diagram illustrating an example architecture of an electronic device that may be utilized to implement content management across multiple mediums, arranged in accordance with at least some embodiments described herein;

FIG. 3 shows a schematic block diagram illustrating another example architecture of an electronic device that may be utilized to implement content management across multiple mediums, arranged in accordance with at least some embodiments described herein;

FIG. 4 shows an example flow diagram of a process for implementing a content management scheme across multiple mediums, arranged in accordance with at least some embodiments described herein;

FIG. 5 illustrates an example computer program product that may be utilized to implement a content management scheme across multiple mediums, arranged in accordance with at least some embodiments described herein; and

FIG. 6 is a block diagram illustrating an example computing device that may be utilized to implement a content management scheme, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the drawings, can be arranged, substituted, combined, separated, and designed in a wide variety of different configurations, all of which are explicitly contemplated herein.

This disclosure is generally drawn, inter alia, to methods, apparatuses, systems, devices, and computer program products related to managing media files across multiple mediums. Further, technologies are herein generally described for managing the media files with information regarding the media file that has been added via at least one social networking service (SNS).

In some examples, an electronic device (e.g., a smartphone, a mobile phone, a personal digital assistant, a tablet, a personal computer such as a laptop computer or a desktop computer, a digital camera, a television, a gaming console, a cloud storage server configured to store data files, etc.) may locally store one or more media files such as, for example, an image file, an audio file, a video file, etc. The electronic device may upload, i.e., post, to at least one social networking service (SNS) server, a particular media file among the one or more media files. In such cases, other users may present their reactions to the posted media file, by, for example, giving favorability ratings for the media file, or posting comments to the media file, etc. Additionally and/or alternatively, the SNS server may detect at least some information regarding the posted media file such as, for example, persons and their moods in the media file, time and location at which the media file was created, and so on (e.g., via facial recognition, mood recognition, object recognition, etc.).

In some examples, the SNS server may transmit, to the electronic device, the posted reactions of the other users and/or the detected information regarding the posted media file. Then, the electronic device may locally store the posted reactions and/or the detected information in connection with the media file as metadata of the media file or as a separate tag file associated with the media file. Accordingly, the electronic device may display one or more of the posted reactions and/or the detected information in connection with the media file (e.g., by a media file browser/player application or an operating system hosted on the electronic device, etc.), when the user browses the media file.

In some further examples, the electronic device may analyze the metadata of the media file (e.g., also by the media file browser/player application or the operating system hosted on the electronic device, etc.), and recommend where to upload another media file based at least in part on the analysis.

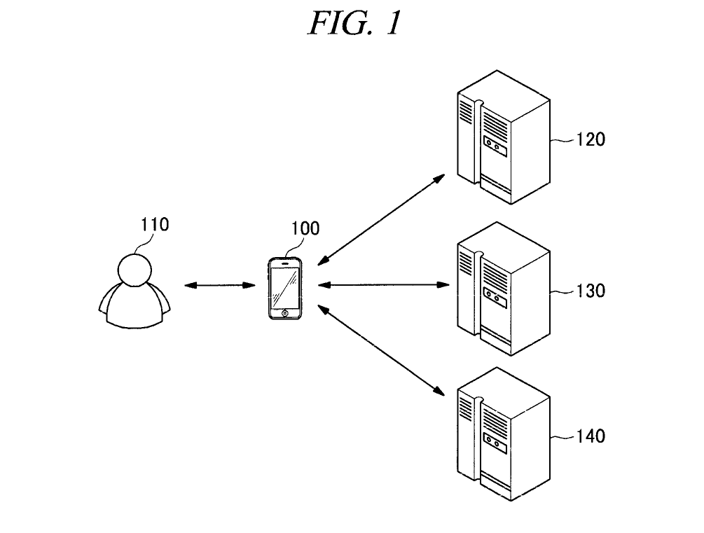

FIG. 1 schematically shows an illustrative example of an environment in which an electronic device interacts with one or more social networking service (SNS) servers to implement content management across multiple mediums, arranged in accordance with at least some embodiments described herein.

As depicted, an electronic device 100 owned and/or controlled by a user 110 who has subscribed to multiple social networking service (SNS) may communicate with multiple SNS servers including SNS servers 120, 130 and 140 over a network such as, for example, the Internet, a cellular network, a wide area network (WAN), a metropolitan area network (MAN), a local area network (LAN), a campus area network (CAN), a virtual private network (VPN), etc. Electronic device 100 may be of any type of electronic device configured to store, retrieve, compute, transmit and/or receive data. Non-limiting examples of electronic device 100 may include a smartphone, a mobile phone, a personal digital assistant, a tablet computer, a personal computer such as a laptop computer or a desktop computer, a digital camera, a television, a gaming console, a cloud storage server, etc.

In some embodiments, electronic device 100 may upload, i.e., post, a media file (e.g., an image file, an audio file or a video file, etc.) respectively to one or more of SNS servers 120, 130, and 140. For instance, when electronic device 100 uploads the media file to SNS servers 120 and 130, SNS servers 120 and 130 may respectively receive, from other users, one or more user reactions including, for example, favorability ratings for the media file, and/or comments posted to the media file. Additionally and/or alternatively, SNS servers 120 and 130 may also detect information regarding the media file such as, for example, persons and their moods in the media file, time and location at which the media file was created, and so on (e.g., via facial recognition, mood recognition, object recognition, etc., all of which are conventional and existing methods). Then, SNS servers 120 and 130 may respectively transmit to electronic device 100, information regarding the posted media file including the favorability ratings for the media file, information regarding authors of respective ones of the favorability ratings for the media file, the comments posted to the media file, information regarding authors of respective ones of the comments posted to the media file, and/or their own detected information regarding the media file.

In some embodiments, electronic device 100 may receive the information when receiving push notification messages respectively from one or more of SNS servers 120, 130, and 140. Electronic device 100 may receive the information in either a push or pull manner. Further, electronic device 100 may receive the information when electronic device 100 accesses the respective SNS servers 120, 130, and 140.

In some embodiments, electronic device 100 may locally store the received information in connection with the posted media file. By way of example, but not limitation, electronic device 100 may store the information as metadata of the media file, or as a separate tag file associated with the media file. Then, in some embodiments, electronic device 100 may show the received information with the media file (e.g., by a content manager in a media file browser/player application or an operating system hosted on electronic device 100, etc.), when user 110 browses the media file or electronic device 100 plays the media file.

In some embodiments, electronic device 100 (e.g., the content manager in the media file browser/player application or the operating system hosted on electronic device 100, etc.) may analyze the received information that may include one or more user reactions. By way of example, but not limitation, electronic device 100 (e.g., the content manager) may calculate a ratio between the number of users who viewed/played the media file and the number of users who gave positive reactions (e.g., by clicking a “like” button in Facebook®), and determine popularity of the media file based on the calculated ratio. By way of another example, but not limitation, electronic device 100 (e.g., the content manager) may count favorable words/expressions appeared in the comments (such as “nice,” “cool,” “awesome,” “envy,” etc.) and also count negative words/expressions appeared in the comments (such as “no way,” “stupid,” “idiot,” “disgusting,” etc.). Any existing methods to mine the positive expressions and negative expressions from the comments may be employed. Also, in some other embodiment, SNS server 120, 130, or 140, instead of electronic device 100 (e.g., the content manager), may analyze the reactions and provide results of the analysis to electronic device 100 (e.g., the content manager). In such cases, the results of the analysis may be in form of “liked,” “neutral,” “popular,” “shared a lot,” “unpopular,” “disliked,” “banned,” etc.

In some further embodiments, electronic device 100 may analyze the received information based on, at least, metadata of the media file (e.g., by the content manager in the media file browser/player application or the operating system hosted on electronic device 100, etc.). By way of example, but not limitation, the metadata may include location information regarding the media file (e.g., GPS coordinates, etc.), time information regarding the media file, one or more people depicted in the media file (e.g., detected by facial recognition, etc.), moods of the one or more people depicted in the media file (e.g., detected by mood recognition, etc.), a title of the media file (e.g., detected from respective ones of the SNSs, etc.), a description added to the media file at the time of posting (e.g., detected from respective ones of the SNSs, etc.), context mining from the comments to the media file (e.g., detected from respective ones of the SNSs, etc.), and so on. For instance, electronic device 100 (e.g., the content manager) may determine that a photo was taken in front of Eiffel Tower based on the location information, or may extract or detect Eiffel Tower from the photo by object recognition. Alternatively, SNS server 120, 130, or 140, instead of electronic device 100 (e.g., the content manager), may perform object recognition and/or location detection, and tag “Eiffel Tower” to the photo, and send such tag information to electronic device 100 (e.g., the content manager). Additionally and/or alternatively, electronic device 100 (e.g., the content manager) and/or SNS server 120, 130, or 140 may perform facial recognition, mood recognition, and so on. Then, electronic device 100 (e.g., the content manager) may classify the media file into categories such as, for example, “with friends,” “with family,” “with work colleagues,” “at home,” “at office,” “at sightseeing place,” “noon,” “night,” “sad mood,” “funny,” “rainy day,” “bright day,” “formal dress,” “casual dress,” “smile,” “crying,” “out of focus,” “red-eye” etc. The reaction may also be classified into categories such as, for example, “liked,” “disliked,” “ignored,” “popular,” and etc. Then, electronic device 100 (e.g., the content manager) may have a data set that indicates a fun family sightseeing photo may be liked at a particular SNS, but not liked/received neutral or negative reaction from another SNS. Also, the data set may depict that a photo taken at office with serious face at 2 am is received warm regards from an SNS, but blamed at another SNS.

Then, in some embodiments, electronic device 100 (e.g., the content manager in the media file browser/player application or the operating system hosted on electronic device 100, etc.) may predict the other users' reactions to the media file on another SNS (e.g., hosted by SNS server 140) based on the user reactions for the media file uploaded to SNS servers 120 and 130. In some other embodiments, electronic device 100 may determine similarity between the media file and other media files (e.g., based on whether they are made at the same time, at the same location, and/or with the same people, etc.), and then predict the other users' reactions to the other media files on the SNSs, predict who may or may not be interested in the other media files, and/or recommend where to upload the media file or the other media files based on, at least, the analysis (e.g., based on the previous user reactions for the media file that was uploaded to SNS servers 120 and 130, etc.). By way of example, but not limitation, when user 110 takes a picture with electronic device 100, and user 110 selects a “share” function embodied by electronic device 100, electronic device 100 may display a list of available sharing methods so that user 110 may select one of the available sharing methods to share the picture. The available sharing methods may include, but are not limited to, sending the picture via a message, sending the picture via an electronic mail, uploading the picture to SNS server 120, uploading the picture to SNS server 130, or uploading the picture to SNS server 140, etc. Electronic device 100 (e.g., the content manager) may modify the list of the available sharing methods in accordance with the media file to be uploaded and/or using the data set. For instance, electronic device 100 (e.g., the content manager) may display some of SNS servers 120, 130 and 140 that may be expected to receive positive feedback, or arrange/sort order of displaying of the available sharing methods. Additionally and/or alternatively, when user 110 selects SNS server 120 to share the picture, electronic device 100 (e.g., the content manager) may show the predicted reactions, such as “would be liked” or “may be unpopular,” etc.

In accordance with at least one non-limiting example, user 110 may upload personal photos to SNS server 120 and further upload work-related photos to SNS server 130. By way of example, but not limitation, electronic device 100 may determine that a particular photo is a personal photo when metadata of the photo indicates that the photo was captured at home, the photo was captured at weekends, and/or family members of user 110 are depicted in the photo. By way of another example, but not limitation, electronic device 100 may determine that the photo is work-related when the metadata indicates that the photo was captured at office, the photo was captured during daytime of normal working days, and/or coworkers of user 110 are depicted in the photo. Then, when user 110 wants to share a new work-related photo, electronic device 100 may recommend (or set as default) that the new work-related photo be uploaded to SNS server 130.

In accordance with another non-limiting example, when photos of a personal nature, e.g., regarding a birthday party, have been posted to one of SNS servers 120, 130, or 140, but have received negative feedback from those who have viewed the photo (e.g., when those who have viewed the photo expressly disliked the photos, or posted negative comments, etc.), electronic device 100 may recommend user 110 not to upload other similar personal photos (e.g., photos taken at the same time and at the same location) when user 110 tries to upload them.

Although FIG. 1 illustrates that electronic device 100 interacts with three SNS servers, those skilled in the art will readily appreciate that electronic device 100 may interact with any number of SNS servers depending on the number of SNSs to which user 110 subscribed. Further, although FIG. 1 illustrates that user 110 uses one electronic device to use SNSs, those skilled in the art will readily appreciate that user 110 may use multiple electronic devices. In such cases, the multiple electronic devices may be synchronized with one another to manage the media file and the information regarding the media file that has been added via the SNSs.

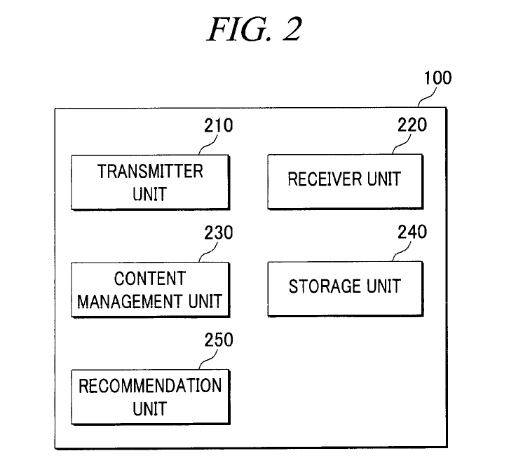

FIG. 2 shows a schematic block diagram illustrating an example architecture of electronic device 100 that may be utilized to implement content management across multiple mediums, arranged in accordance with at least some embodiments described herein. Reference may be made to the embodiments depicted and described with reference to FIG. 1.

As depicted, electronic device 100 may include a transmitter unit 210, a receiver unit 220, a content management unit 230, a storage unit 240, and a recommendation unit 250. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or any combination thereof.

Transmitter unit 210 may be configured to transmit a media file to a server (e.g., SNS server 120, 130, or 140). The media file may include at least one of an image file, an audio file or a video file.

Receiver unit 220 may be configured to receive, from the one or more SNS servers to which a particular media file has been transmitted, information regarding the media file that has been added via the server. By way of example, but not limitation, the information may include at least one of favorability ratings for the media file, information regarding authors of respective ones of the favorability ratings for the media file, comments posted to the media file, or information regarding authors of respective ones of the comments posted to the media file.

Content management unit 230 may be configured to associate the received information with the media file. In some embodiments, content management unit 230 may be configured to add the received information to the media file as metadata. In some other embodiments, content management unit 230 may be configured to generate a tag file associated with the media file that may include the received information.

Storage unit 240 may be configured to store the media file and the information associated with the media file.

Recommendation unit 250 may be configured to analyze the received information based on, at least, metadata of the media file, and generate a recommendation regarding where to upload another media file in the storage based on, at least, the analysis. By way of example, but not limitation, the metadata of the media file may include location information regarding the media file (e.g., GPS coordinates, etc.), time information regarding the media file, other persons in the media file (e.g., detected by facial recognition, etc.), a title of the media file (e.g., detected from the SNSs, etc.), explanation on the media file (e.g., detected from the SNSs, etc.), context mining from the comments to the media file (e.g., detected from the SNSs, etc.), and so on.

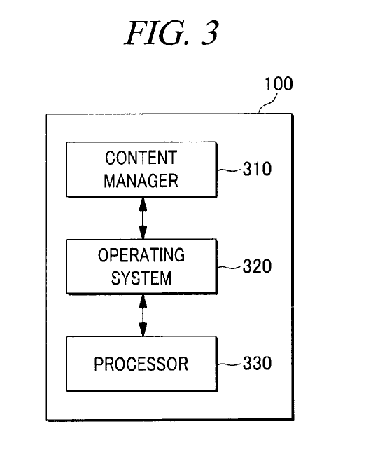

FIG. 3 shows a schematic block diagram illustrating another example architecture of electronic device 100 that may be utilized to implement content management across multiple mediums, arranged in accordance with at least some embodiments described herein. Reference may be made to the embodiments depicted and described with reference to FIGS. 1-2.

As depicted, electronic device 100 may include a content manager 310, an operating system 320 and a processor 330. Content manager 310 may be an application adapted to operate on operating system 320 such that a content management scheme, as described herein, may be provided. Operating system 320 may allow content manager 310 to manipulate processor 330 to implement the content management scheme as described herein. In some embodiments, content manager 310 may include one or more components or program modules respectively adapted to implement functions of content management unit 230 and/or recommendation unit 250 as illustrated in FIG. 3.

Although FIG. 3 illustrates that content manager 310 is an application separate from operating system 320, it will be understood by those skilled in the art that content manager 310 may also be implemented as a component of operating system 320, depending on the desired configuration. Also, content manager 310 may be a component of a media file browser/recorder/player application such as, for example, a photo gallery application, a voice recorder/player application, a video/player recorder application, etc.

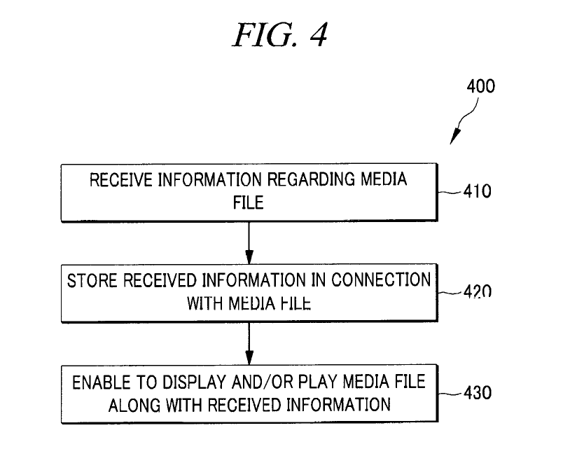

FIG. 4 shows an example flow diagram of a process 400 for implementing a content management scheme across multiple mediums, arranged in accordance with at least some embodiments described herein.

Process 400 may be implemented in an electronic device such as electronic device 100 including, for example, transmitter unit 210, receiver unit 220, content management unit 230, storage unit 240, and recommendation unit 250. Thus, reference may be made to the embodiments depicted and described with reference to FIGS. 1-3. Process 400 may include one or more operations, actions, or functions as illustrated by one or more blocks 410, 420 and/or 430. Although illustrated as discrete blocks, various blocks may be divided into additional blocks, combined into fewer blocks, or eliminated, depending on the desired implementation. Processing may begin at block 410.

At block 410 (Receive Information Regarding Media File), electronic device 100 (e.g., receiver unit 220) may receive, from a respective one of one or more servers (e.g., SNS servers 120, 130 and 140 illustrated in FIG. 1) to which a media file has been uploaded, information regarding the media file that has been added via the respective one of the one or more servers. The information may include, but is not limited to, at least one of favorability ratings for the media file, information regarding authors of respective ones of the favorability ratings for the media file, comments posted to the media file, or information regarding authors of respective ones of the comments posted to the media file. Electronic device 100 may receive the information in one or both of a push or pull manner. Further, electronic device 100 may receive the information when accessing the respective one of the one or more servers. Processing may continue from block 410 to block 420.

At block 420 (Store Received Information in Connection with Media File), electronic device 100 (e.g., content management unit 230) or content manager 310 may locally store (e.g., in storage unit 240) the received information in connection with the media file. In some embodiments, electronic device 100 or content manager 310 may store the information as metadata of the media file. Additionally and/or alternatively, electronic device 100 or content manager 310 may store the information as a separate tag file associated with the media file. Processing may continue from block 420 to block 430.

At block 430 (Enable to Display and/or Play Media File along with Received Information), electronic device 100 may be enabled to display and/or play the media file along with the received information.

As such, user 110 may conveniently browse the media file with information regarding the media file that has been added via even multiple SNSs.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

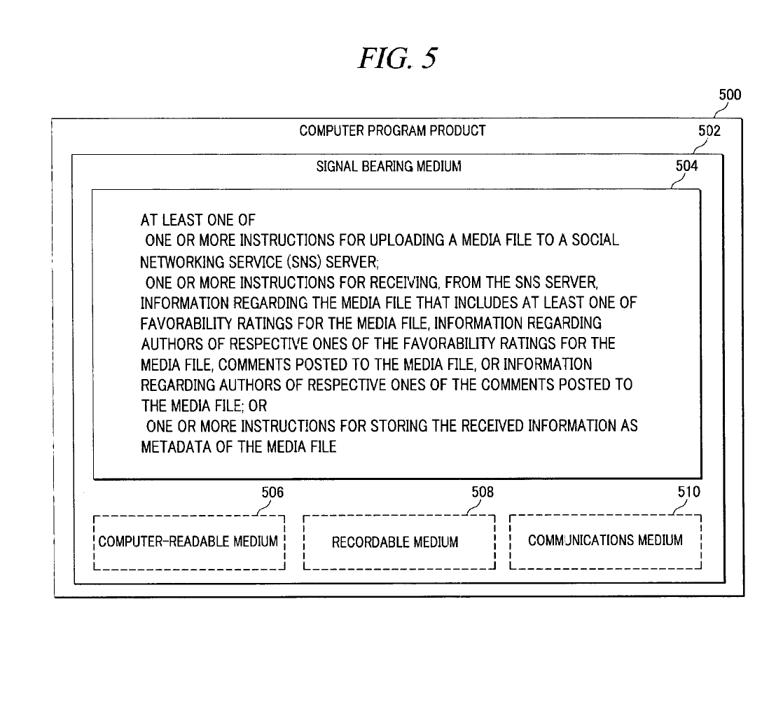

FIG. 5 illustrates an example computer program product 500 that may be utilized to implement a content management scheme across multiple mediums, arranged in accordance with at least some embodiments described herein.

As depicted, program product 500 may include a signal bearing medium 502. Signal bearing medium 502 may include one or more instructions 504 that, when executed by, for example, processor 330 of electronic device 100, may provide the functionality described above with respect to FIGS. 1-4. By way of example, instructions 504 may include: one or more instructions for uploading a media file to a social networking service (SNS) server; one or more instructions for receiving, from the SNS server, information regarding the media file that includes at least one of favorability ratings for the media file, information regarding authors of respective ones of the favorability ratings for the media file, comments posted to the media file, or information regarding authors of respective ones of the comments posted to the media file; or one or more instructions for storing the received information as metadata of the media file.

In some implementations, signal bearing medium 502 may encompass a computer-readable medium 506, such as, but not limited to, a hard disk drive, a CD, a DVD, a digital tape, memory, etc. In some implementations, signal bearing medium 502 may encompass a recordable medium 508, such as, but not limited to, memory, read/write (R/W) CDs, R/W DVDs, etc. In some implementations, signal bearing medium 502 may encompass a communications medium 510, such as, but not limited to, a digital and/or an analog communication medium (e.g., a fiber optic cable, a waveguide, a wired communications link, a wireless communication link, etc.). Thus, for example, program product 500 may be conveyed to one or more modules of electronic device 100 by an RF signal bearing medium 502, where the signal bearing medium 502 is conveyed by a wireless communications medium 510 (e.g., a wireless communications medium conforming with the IEEE 802.11 standard).

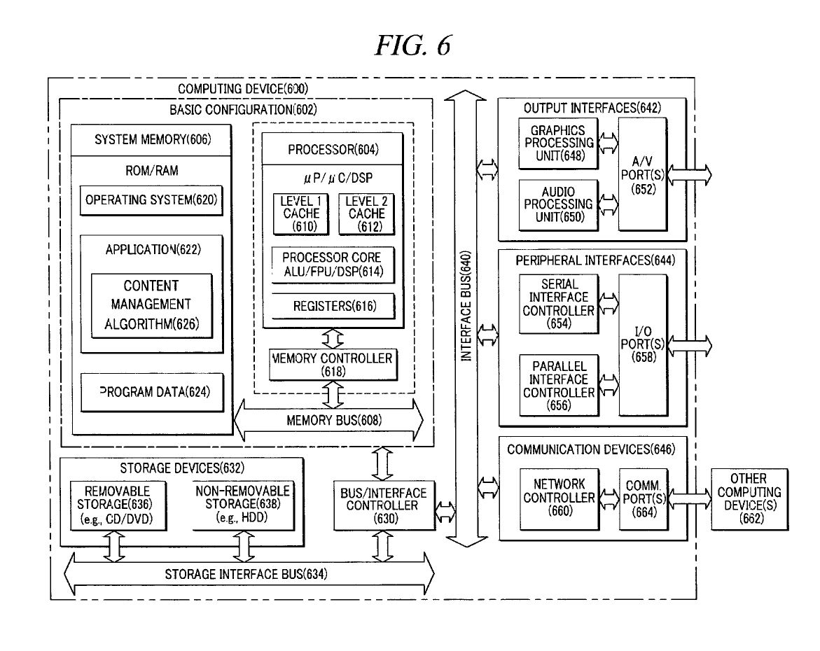

FIG. 6 is a block diagram illustrating an example computing device 600 that may be utilized to implement a content management scheme, arranged in accordance with at least some embodiments described herein.

In a very basic configuration 602, computing device 600 typically includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one or more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624.

Application 622 may include a content management algorithm 626 that may be arranged to perform the functions as described herein including the actions described with respect to the electronic device 100 architecture as shown in FIG. 2-3 or including the actions described with respect to the flow chart shown in FIG. 4. Program data 624 may include any data that may be useful for providing the content management scheme as is described herein. In some examples, application 622 may be arranged to operate with program data 624 on an operating system 620 such that the content management scheme as described herein may be provided.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method comprising:
uploading, by an electronic device, to a server of at least one social networking service (SNS), a media file stored in the electronic device;
receiving, by the server, one or more user reactions to the media file;
transmitting, by the server, to the electronic device, the one or more user reactions;
storing, by the electronic device, the one or more user reactions, received from the server of the at least one SNS, in connection with the media file; and
showing, by the electronic device, the one or more user reactions in connection with the media file when a user of the electronic device browses the media file.

2. The method of claim 1, wherein the one or more user reactions include at least one of favorability ratings for the media file, or comments posted to the media file.

3. The method of claim 1, wherein the storing comprises storing the one or more user reactions as metadata of the media file.

4. The method of claim 1, wherein the storing comprises storing the one or more user reactions as a separate tag file associated with the media file.

5. A method performed under control of a content manager, comprising:
receiving, from a respective one of one or more servers to which a media file has been uploaded, information regarding the media file that has been added via the respective one of the one or more servers;
storing, in a storage, the received information in connection with the media file;
analyzing the received information based on, at least, metadata of the media file; and
recommending where to upload another media file based at least in part on the analysis.

6. The method of claim 5, wherein the one or more servers include social networking service (SNS) servers, and
wherein the information includes at least one of favorability ratings for the media file, information regarding authors of respective ones of the favorability ratings for the media file, comments posted to the media file, or information regarding authors of respective ones of the comments posted to the media file.

7. The method of claim 5, wherein the storing comprises storing the information as the metadata of the media file.

8. The method of claim 5, wherein the storing comprises storing the information as a separate tag file associated with the media file.

9. The method of claim 5, wherein the receiving of the information is performed when receiving a push notification message from the respective one of the one or more servers.

10. The method of claim 5, wherein the receiving of the information is performed periodically.

11. The method of claim 5, wherein the receiving of the information is performed when an electronic device on which the content manager is hosted accesses the respective one of the one or more servers.

12. The method of claim 5, further comprising:
enabling an electronic device on which the content manager is hosted to play the media file along with the received information.

13. (canceled)

14. The method of claim 5, wherein the media file includes at least one of an image file, an audio file or a video file.

15. The method of claim 5, wherein the content manager is hosted on a user terminal or a cloud storage device.

16. An electronic device comprising:
a transmitter unit configured to transmit a media file to a server, the server includes a social networking service (SNS) server;
a receiver unit configured to receive, from the server, information regarding the media file that has been added via the server;
a content management unit configured to associate the received information with the media file; and
a storage unit configured to store the media file and the information, received from the server includes the SNS server, associated with the media file.

17. The electronic device of claim 16,
wherein the information includes at least one of favorability ratings for the media file, information regarding authors of respective ones of the favorability ratings for the media file, comments posted to the media file, or information regarding authors of respective ones of the comments posted to the media file.

18. The electronic device of claim 16, wherein the content management unit is further configured to add the received information to the media file as metadata.

19. The electronic device of claim 16, wherein the content management unit is further configured to generate a tag file associated with the media file that includes the received information, and
wherein the storage unit is further configured to store the tag file associated with the media file.

20. The electronic device of claim 16, further comprising:
a recommendation unit configured to analyze the received information based on, at least, metadata of the media file, and generate a recommendation regarding where to upload another media file in the storage based at least in part on the analysis.

21. The electronic device of claim 16, wherein the media file includes at least one of an image file, an audio file or a video file.

22. A non-transitory computer-readable storage medium having stored thereon computer-executable instructions that, in response to execution, cause a processor to perform operations, comprising:
uploading a media file to a social networking service (SNS) server;
receiving, from the SNS server, information regarding the media file that includes at least one of favorability ratings for the media file, information regarding authors of respective ones of the favorability ratings for the media file, comments posted to the media file, or information regarding authors of respective ones of the comments posted to the media file; and
storing the received information as metadata of the media file.
